(19) United States
(12) Patent Application Publication
(10) Pub. No.: US 2013/0097707 A1
(43) Pub. Date: Apr. 18, 2013

(54) TERMINAL AND METHOD FOR TERMINAL TO DETERMINE FILE DISTRIBUTOR

(71) Applicants: Yongseok Hwang, Seoul (KR); Jeonghun Kim, Seoul (KR); Sunghyun Kim, Seoul (KR); Kyungwan Kang, Seoul (KR)

(72) Inventors: Yongseok Hwang, Seoul (KR); Jeonghun Kim, Seoul (KR); Sunghyun Kim, Seoul (KR); Kyungwan Kang, Seoul (KR)

(73) Assignee: AHNLAB, INC., Gyeonggi-do (KR)

(21) Appl. No.: 13/639,598

(22) PCT Filed: Apr. 5, 2011
(86) PCT No.: PCT/KR2011/002339

§ 371 Date: Nov. 12, 2012

(30) Foreign Application Priority Data
Apr. 5, 2010 (KR) 10-2010-0030939

(51) Int. Cl. H04L 29/06

(52) U.S. Cl. CPC H04L 63/1441
USPC 726/24

(57) ABSTRACT

Provided are a terminal and a file distributor determining method of the terminal. According to embodiments of the present invention, files pre-executed in the terminal and distributor information of the files are cached. When a new file is generated in the terminal, the new file and the cached files are compared, and distributor information of the new file is extracted so as to prevent the spread of a malicious code in advance.

### TECHNICAL FIELD

The present disclosure relates to a technology of determining a distributor and a distribution route of a file that is transferred to a user terminal, so as to prevent the spread of a malicious code in advance.

### BACKGROUND ART

As a high-speed Internet environment has been established, the number of cases of damage occurring due to a malicious code that is spread through a program, an e-mail, and the like has rapidly increased.

In general, the malicious code may decrease a speed of a computer, may fix an initial page of a web browser to a risky site, may use a computer of a user as a sending server of a spam mail or as a foothold PC of distributed denial of service attack (DDoS), or may leak personal information of a user.

The malicious code is installed in a computer of a user and damages the computer in various ways, such as ActiveX, Java Applet, Java WebStart, .NET ClickOnce, Flash, UCC, and the like. However, they have a common point in that files are received from the outside.

Recently, various studies on defense mechanisms to prevent the spread of the malicious code have been conducted.

First, an installation-type program to prevent the malicious code is a program that is installed in each personal computer. The installation-type program may detect execution of a malicious code, a virus, or obscene materials based on a malicious code signature database which is previously manufactured and distributed, and may treat an infected computer. General vaccine programs may correspond to the installation-type program.

As another method to prevent the malicious code, a scheme may be used that blocks traffic based on a URL DB of risky sites which are classified by a firewall installed in a front side of a network. URLs may be collected through various schemes.

As described in the foregoing, although varied schemes to prevent the malicious code exist, there may be a desire for research on a defense method to prevent installation of a malicious code in advance, early detection of the malicious code, and tracing of a distributor of the malicious code, since in many cases the malicious code is installed in a computer due to carelessness of a user.

### DISCLOSURE

### Technical Problem

Therefore, embodiments of the present invention have been made in view of the above-mentioned problems, and an aspect of the present invention is to configure a method of tracing a distributor and a distribution route of a file that is transferred to a terminal of a user via a web and the like, so as to provide a way to fundamentally prevent the spread of a malicious code.

### Technical solution

In accordance with an aspect of the present invention, there is provided a terminal, including: a cache unit storing an identification value associated with at least one file pre-executed in the terminal and distributor information associated with the at least one file; a detecting unit to detect whether a new file is generated in the terminal; an identification value generating unit to generate an identification value of the new file when the generation of the new file is detected; and an extracting unit to extract, from the cache unit, distributor information of a file having an identification value identical to the identification value of the new file.

In accordance with another aspect of the present invention, there is provided a file distributor determining method of a terminal, the method including: managing a database (DB) storing an identification value associated with at least one file pre-executed in the terminal and distributor information associated with the at least one file; detecting whether a new file is generated in the terminal; generating an identification value of the new file when the generation of the new file is detected; and extracting, from the DB, distributor information associated with a file having an identification value identical to the identification value of the new file.

### Advantageous Effects

According to embodiments of the present invention, files pre-executed in a terminal and distributor information of the files are cached. When a new file is generated in the terminal, the new file and the cached files are compared, distributor information of the new file is extracted so as to help analyze a malicious code and to prevent the spread of the malicious code in advance.

### BRIEF DESCRIPTION OF THE DRAWING

The foregoing and other objects, features and advantages of the present invention will become more apparent from the following detailed description when taken in conjunction with the accompanying drawings in which:

FIG. 1 is a diagram illustrating a structure of a terminal according to an embodiment of the present invention;

FIG. 2 is a diagram illustrating a method for a terminal to trace a distribution route of a file according to an embodiment of the present invention;

FIG. 3 is a flowchart illustrating a method for a terminal to determine a distributor of a file according to an embodiment of the present invention; and

FIG. 4 is a flowchart illustrating a method for a terminal to trace a distribution route of a file according to an embodiment of the present invention.

### DETAILED DESCRIPTION

Hereinafter, embodiments of the present invention will be described in detail with reference to the accompanying drawings. However, the present invention is not limited to the embodiments. When referring to the drawings, similar reference numerals are used for similar components.

As described in the foregoing, since a number of damage cases occurring due to a malicious code has increased, a process of determining a distributor of a malicious code may be needed so as to prevent the spread of the malicious code in the early stage.

When the distributor of the malicious code is recognized, execution of a file transferred from the distributor may be fundamentally blocked and thus, the spread of the malicious code may be prevented.

That is, when a distributor of a file transferred to a terminal of a user is a reliable uniform resource locator (URL) or when the file corresponds to a file extracted from a cab file or an exe file including an electronic signature, the file may be determined to be a reliable file. Conversely, when the distributor of the file corresponds to a distributor that distributes a malicious code, execution of the file may be blocked and thus, installation of the malicious code in the terminal may be fundamentally prevented.

Here, the distributor of the file may refer to a place (for example, a URL) where the file is derived, such as a network route including a URL, a recoding medium, a compressed file, a different process, and the like, or may refer to something (for example, a process that generates a file) that exists en route when a file is generated in a terminal.

Also, in many cases, a recent malicious code is formed of a code that attacks a weak point, and many modules such as a downloader, a body, and the like and thus, it is importable to detect a distribution route of the malicious code.

Therefore, embodiments of the present invention may provide a method of tracing a distributor and a distribution route of a file transferred to a terminal of a user via a web and the like, so as to provide a way to fundamentally prevent the spread of a malicious code.

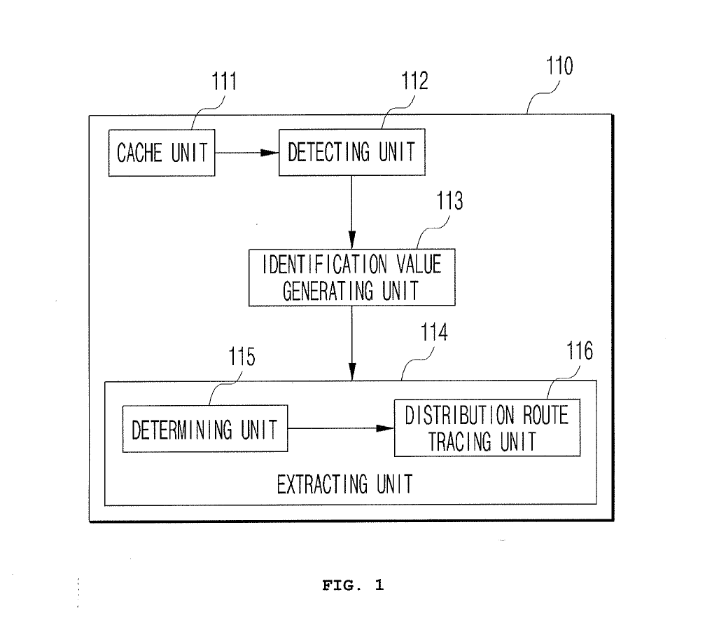

First, a terminal according to an embodiment of the present invention will be described with reference to FIG. 1.

FIG. 1 illustrates a structure of a terminal according to an embodiment of the present invention.

Referring to FIG. 1, a terminal 110 may include a cache unit 111, a detecting unit 112, an identification value generating unit 113, and an extracting unit 114.

Here, the terminal 110 may be an inclusive concept of a microprocessor-based device, such as a personal computer (PC), a server, an MP3 player, a PMP, a navigation terminal, a mobile terminal, a PDA, and the like.

The cache unit 111 may include an identification value associated with at least one file pre-executed in the terminal 110 and distributor information associated with the at least one file.

In this example, the identification value associated with the at least one file may correspond to a hash value of the at least one file or a portion or the entirety of the at least one file.

Also, the cache unit 111 may include route information required for back-tracing a file and the like.

The detecting unit 112 may detect whether a new file is generated in the terminal 110.

The identification value generating unit 113 may generate an identification value of the new file when the generation of the new file is detected.

In this example, the identification value of the new file may correspond to a hash value of the new file or a portion or the entirety of the new file.

The extracting unit 114 may extract distributor information associated with a file having an identification value identical to the identification value of the new file.

That is, when the terminal 100 receives the new file via a web and the like after performing caching of identification values of previously executed files and distributor information of the files, the terminal 100 may compare the identification value of the new file and the identification values of the files that are cached in advance, may extract the distributor information associated with the file having the identification value identical to the identification value of the new file, so that a user may determine a distributor of the new file.

In general, a distributor of a file transferred to the terminal 110 may include a web, a recording medium, a compressed file, a predetermined process, and the like.

Therefore, detailed operations of the terminal 110 will be described for each type of a distributor of a file.

An Embodiment in the Case where a File is Distributed via a Web

First, the detecting unit 112 may investigate a packet that is received by the terminal 110 through a network filter, so as to determine whether a network connection of the terminal 110 corresponds to an identifiable connection such as HTTP and the like.

When the network connection is the identifiable connection, the cache unit 111 may perform caching of information associated with a host and the like in a protocol.

In this example, when the detecting unit 112 investigates all the packets received by the terminal 110, performance of the detecting unit 112 may be deteriorated. Therefore, the detecting unit 112 may investigate only a few of the received packets after the terminal 110 is connected to a network.

In this example, when the protocol corresponds to a protocol that supports a continuous connection such as HTTP1.1, the detecting unit 112 may need to detect a packet where a new transaction starts in an existing connection.

In the case where the protocol is a parsable protocol such as HTTP and the like when the terminal 110 receives a packet, the detecting unit 112 may parse the protocol and may determine whether the file is included.

In this example, when the protocol corresponds to HTTP, the detecting unit 112 may determine a content type of a header and data of a body, so as to determine whether a file is included and determine a type of the file.

However, when the protocol is an unidentified protocol, the detecting unit 112 may investigate a few of the received packets and may determine whether an identified file format exists.

In this example, the detecting unit 112 may detect an execution file of an RAW format or a compressed format such as ZIP. In this example, when a file detected by the detecting unit 112 corresponds to a compressed format or other identifiable formats, the detecting unit 112 may process the file so as to detect an internal file.

When the detecting unit 112 completes determining of the file based on the received packet, the identification value generating unit 113 may generate a portion of the file such as a file header or the entirety of the file, and the cache unit 111 may perform caching of the portion or the entirety of the file.

In this example, the identification value generating unit 113 may generate a hash value of the file, and the cache unit 111 may perform caching of the hash value.

The cache unit 111 may perform caching of the file, and simultaneously, may perform caching of network information, such as a URL of a distributor of the file, an Internet protocol (IP) address, a port number, and the like.

That is, when the detecting unit 112 extracts files distributed via a web and network information of distributors of the files based on the packet received by the terminal 110, and generates identification values of the extracted files, the cache unit 111 may perform caching of the identification values and the network information.

When a new file is generated in the terminal 110 after the cache unit 111 performs caching of the identification values of the files transferred to the terminal 110 and the network information of the distributors of the files, the detecting unit 112 may detect whether the new file is generated.

When a portion or the entirety of the file is stored in the cache unit 111, the extracting unit 114 may determine whether a file identical to the new file exists in the cache unit 111. When the identical file exists, the extracting unit 114 may extract, from the cache unit 111, network information of a distributor that distributes the identical file, such as URL information.

When the cache unit 111 stores a hash value of a file, the identification value generating unit 113 may generate a hash value of the new file, and the extracting unit 114 may extract, from the cache unit 111, network information of a distributor that distributes a file having a hash value identical to the hash value of the new file.

An Embodiment in the Case where a File is Distributed from a Recoding Medium

First, the detecting unit 112 may detect whether a file is read out from a recoding medium, such as a CD-ROM, a USB memory, and the like, through a file filter. When the file is read out from the recoding medium, the detecting unit 112 may determine information associated with a type of the recoding medium, a file route, and the like.

The identification value generating unit 113 may generate an identification value of the read file, and the cache unit 111 may perform caching of the identification value and the information associated with the type of the recoding medium, the file route, or the like.

When a new file is generated in the terminal 110 after the cache unit 111 performs caching of identification values of files transferred to the terminal 110 and recoding medium type information associated with the files, the detecting unit 112 may detect whether the new file is generated.

The identification value generating unit 113 may generate an identification value of the new file.

When the extracting unit 114 compares the identification values of the files stored in the cache unit 111 and the identification value of the new file, and determines that a file having an identification value identical to the identification value of the new file exists in the cache unit 111, the extracting unit 114 may extract, from the cache unit 11, recoding medium type information associated with a type of a recoding medium that distributes the file having the identical identification value.

An Embodiment in the Case where a File is Distributed from a Compressed File

First, the detecting unit 112 may detect whether data is read out from a compressed file through a file filter.

In this example, when the file is sequentially or similarly read, the detecting unit 112 may read again the compressed file or the read file so as to decompress the file.

Subsequently, the detecting unit 112 may determine information associated with the compressed file during the decompression.

The identification value generating unit 113 may generate identification values of files detected during the decompression, and the cache unit 111 may perform caching of the identification values and the information associated with the compressed file.

When a new file is generated in the terminal 110 after the cache unit 111 performs caching of identification values of files transferred to the terminal 110 and compressed file information associated with the files, the detecting unit 112 may detect whether the new file is generated.

Subsequently, the identification value generating unit 113 may generate an identification value of the new file.

When the extracting unit 114 compares the identification values of the files stored in the cache unit 111 with the identification value of the new file, and determines that a file having an identification value identical to the identification value of the new file exists, the extracting unit 114 may extract, from the cache unit 111, compressed file information that includes a file having the identical identification value.

An Embodiment in the Case where a Predetermined Process Generates a File

First, the case in which a predetermined process generates a file may correspond to a case in which a file is generated from an installation file such as setup.exe or may correspond to a case in which a file is generated from another file.

The detecting unit 112 may detect whether a file is generated from a predetermined process. When the file is generated from the process, the detecting unit 112 may determine information associated with the process.

The identification value generating unit 113 may generate an identification value of the generated file, and the cache unit 111 may perform caching of the identification value and process information associated with a process that distributes the file.

When a new file is generated in the terminal 110 after the cache unit 111 performs caching of identification values of files transferred to the terminal 110 and process information associated with the files, the detecting unit 112 may detect whether the new file is generated.

Subsequently, the identification value generating unit 113 may generate an identification value of the new file.

When the extracting unit 114 compares the identification values stored in the cache unit 111 with the identification value of the new file, and determines that a file having an identification value identical to the identification value of the new file exists in the cache unit 111, the extracting unit 114 may extract, from the cache unit 111, process information associated with a process that distributes the file having the identical identification value.

Also, according to an embodiment of the present invention, when a file is generated from a predetermined process such as an installation file and the like, a distributor of the new file may be determined by determining, from the installation file, an image file of a process that generates a file.

In this example, when “setup”, “install”, or the like is included in a file name, a corresponding file may be regarded as an installation file.

Whether a file corresponds to an installation file may be determined by determining a characteristic of a widely utilized installation generating program such as Installshield and the like.

Detailed operations of the terminal 110 have been described for each type of a distributor of a file.

Although the embodiments have been described separately for ease of description, it does not mean that the embodiments need to be separately applied to the terminal 110.

That is, it is apparent to those skilled in the art that the embodiments may be simultaneously applied to the single terminal 110.

According to an embodiment of the present invention, the terminal 110 may trace a distribution route of a new file based on a distributor of the new file determined based on the method as described in the foregoing.

The extracting unit 114 may include the determining unit 115 and the distribution route tracing unit 116.

The determining unit 115 may determine, based on information associated with the distributor of the new file extracted from the extracting unit 114, whether the new file is distributed from another file.

In this example, when the new file is distributed from another file, the distribution route tracing unit 116 may trace the distribution route of the new file by extracting information associated with a distributor of the other file from the cache unit 111 based on an identification value of the other file.

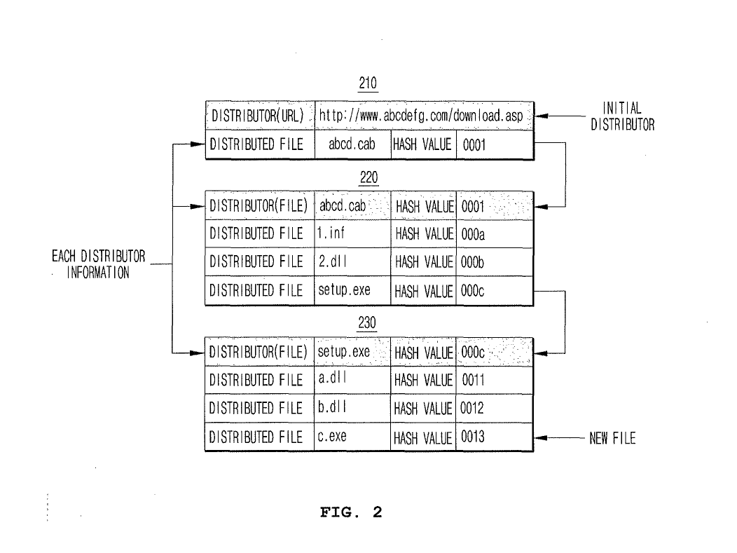

Hereinafter, a process in which the terminal 110 traces a distribution route of a file will be described in detail with reference to FIG. 2.

FIG. 2 illustrates a method for a terminal to trace a distribution route of a file according to an embodiment of the present invention

Here, an identification value of a file is assumed to be a hash value of the file.

First, a new file distributed to the terminal 110 is assumed to be “c.exe,” included in the diagram 230.

When the detecting unit 112 detects generation of “c.exe,” the identification value generating unit 113 may generate a hash value of “c.exe,” that is, “0013.”

Subsequently, the extracting unit 114 may extract, from the cache unit 111, distributor information of a file having a hash value identical to “0013” that is the hash value of “c.exe,”.

In the diagram 230, “setup.exe” is illustrated as a distributor of the file having the hash value identical to “0013” that is the hash value of “c.exe” and thus, the extracting unit 114 may extract “setup.exe” from the cache unit 111.

When the extracting unit 114 extracts “setup.exe”, the determining unit 115 may determine whether “c.exe” corresponds to a file distributed from another file.

“setup.exe” corresponds to a file and thus, the determining unit 115 may determine that “c.exe” is distributed from another file. The distribution route tracing unit 116 may extract distributor information of “setup.exe” from the cache unit 111 based on a hash value of “setup.exe,” that is, “000c.”

In the diagram 220, “abcd.cab” is illustrated as a distributor of “setup.exe” and thus, the distribution route tracing unit 116 may extract “abcd.cab” from the cache unit 111.

In this example, the determining unit 115 may determine that “setup.exe” is distributed from “abcd.cab,” and the distribution route tracing unit 116 may extract distributor information of “abcd.cab” from the cache unit 111 based on a hash value of “abcd.cab,” that is, “0001.”

In the diagram 210, “http://www.abcdefg.com/download.asp” is illustrated as a distributor of “abcd.cab” and thus, the distribution route tracing unit 116 may extract “http://www.abcdefg.com/download.asp” from the cache unit 111.

In this example, the determining unit 115 may determine that “abcd.cab” does not correspond to a file distributed from another file, and may complete a process of extracting distributor information.

As described in the foregoing, the distribution route tracing unit 116 may trace “http://www.abcdefg.com/download.asp” as an initial distributor of “c.exe”, and also may trace that “abcd.cab” is distributed from the initial distributor, “setup.exe” is distributed from “abcd.cab”, and “c.exe,” which is a file newly generated in the terminal 110, is finally distributed from “setup.exe”.

That is, the distribution route tracing unit 116 may trace a distributor of a new file based on a hash value of a file as a chaining file.

According to an embodiment of the present invention, when a new file generated in the terminal 110 has various distribution routes, and one or more reliable distributors are included in the corresponding routes, the terminal 110 may identify the new file as a reliable file.

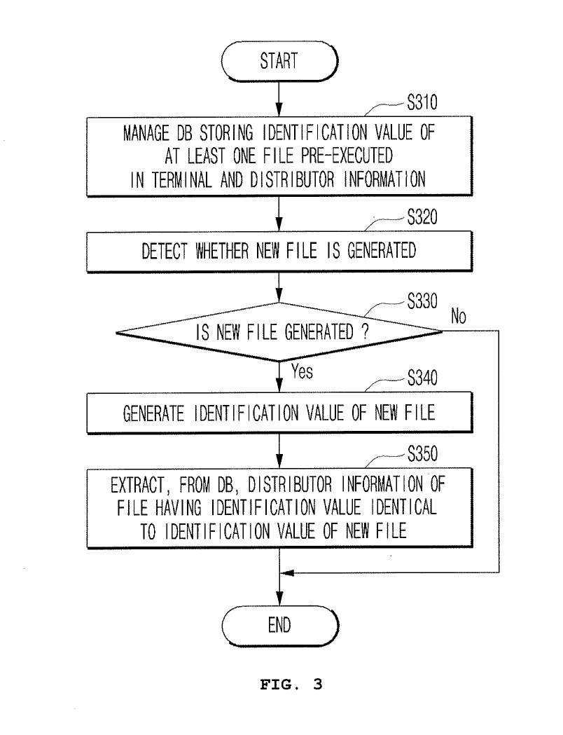

FIG. 3 illustrates a method for a terminal to determine a distributor of a file according to an embodiment of the present invention.

In step S310, a database (DB) storing an identification value of at least one file pre-executed in the terminal and distributor information associated with the at least one file may be managed.

In step S320, whether a new file is generated in the terminal may be detected.

When the generation of the new file is not detected by determining the detection of step S320 in step S330, a corresponding process is completed.

Conversely, when the generation of the new file is detected by determining the detection of step S320 in step S330, an identification value of the new file may be generated in step S340.

In step S350, distributor information associated with a file having an identification value identical to the identification value of the new file may be extracted from the DB in step S350.

The method for the terminal to determine a distributor of a file according to an embodiment of the present invention may further include a predetermined operation after step S350, so as to trace a distribution route of the new file.

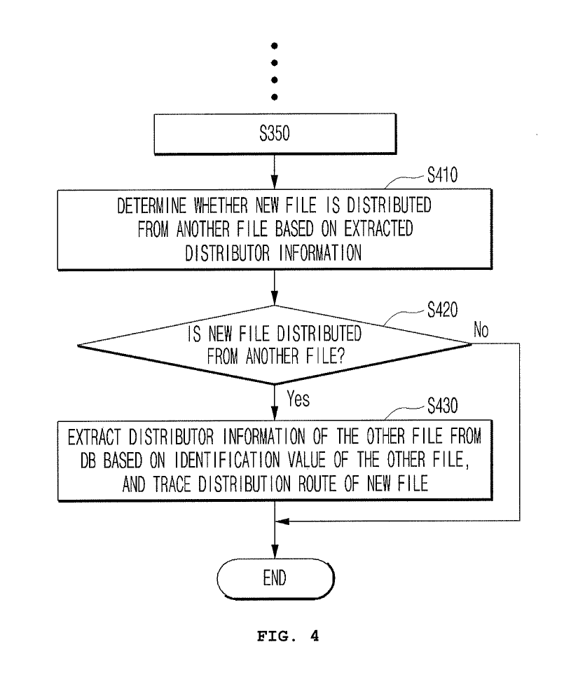

Hereinafter, a process of tracing the distribution route of the new file will be described with reference to FIG. 4.

FIG. 4 illustrates a method for a terminal to trace a distribution route of a file according to an embodiment of the present invention.

In step S410, whether the new file is distributed from another file may be determined based on distributor information extracted in step S350.

When the new file is determined not to correspond to a file distributed from another file in step S420, based on the determination of step S410, a corresponding process may be completed.

Conversely, when the new file is determined to correspond to a file distributed from another file in step S420, based on the determination of step S410, a distribution route of the new file may be traced by extracting distributor information of the other file from the DB based on an identification value of the other file in step S430.

The method for the terminal to determine a distributor of a file according to an embodiment of the present invention has been described with reference to FIGS. 3 and 4. Here, the method for the terminal to determine a distributor of a file may correspond to the configuration of the terminal as described in the foregoing and thus, detailed descriptions thereof will be omitted.

The file distributor determining method of the terminal according to embodiments of the present invention may be executed in a program command form that can be executed through various computer means, and be recorded in a computer-readable recording medium. The computer-readable recoding medium may contain program commands, data files, data structures or the like individually or in combination. The program commands recorded in the medium may be those specially designed for the present invention or those publicly known and used by a person skilled in the art of computer software. Examples of such a computer-readable recording medium include magnetic media, such as a hard disk, a floppy disk and a magnetic tape, optical media, such as a CD-ROM and a DVD, magneto-optical media, such as a floptical disk, and a hardware device specially configured to store and execute a program command, such as a ROM, a RAM and a flash memory. Examples of such a program command include high-level language codes that can be executed by a computer using an interpreter or the like as well as mechanical language codes made by a compiler. The above-mentioned hardware devices may be configured to be operated by one or more software modules to execute the inventive functions, and vice versa.

Although the present invention has been described above in connection with features, such as specific components of the present invention, several embodiments and drawings, these were provided merely to help a thorough understanding of the present invention but not intended to limit the present invention to the embodiments. A person ordinarily skilled in the art to which the present invention pertains can variously modify and change the specific features on the basis of the above disclosure.

Therefore, the idea and technical scope of the present invention cannot be determined merely on the basis of the embodiments described above. Rather, the idea and technical scope of the present invention are determined on the basis of the accompanying claims, and all the changes, equivalents and substitutions belonging to the idea and technical scope of the present invention are included in the present invention.

1. A terminal, comprising:
a cache unit storing an identification value associated with at least one file pre-executed in the terminal and distributor information associated with the at least one file;
a detecting unit to detect whether a new file is generated in the terminal;
an identification value generating unit to generate an identification value of the new file when the generation of the new file is detected; and
an extracting unit to extract, from the cache unit, distributor information of a file having an identification value identical to the identification value of the new file.

2. The terminal as claimed in claim 1,
wherein the detecting unit extracts, the at least one file and network information of a distributor that distributes the at least one file based on a received packet when the at least one file is distributed through a web;
the identification value generating unit generates an identification value associated with the extracted at least one file; and
the cache unit performs caching of the identification value of the at least one file and the network information.

3. The terminal as claimed in claim 1,
wherein the detecting unit determines a type of a recoding medium when the at least one file is read out from the recoding medium in the case where a distributor of the at least one file corresponds to the recoding medium;
the identification value generating unit generates an identification value of the at least one file; and
the cache unit performs caching of the identification value of the at least one file and the information associated with the type of the recoding medium.

4. The terminal as claimed in claim 1,
wherein the detecting unit determines information associated with a compressed file when the compressed file is decompressed in the case where a distributor of the at least one file corresponds to the compressed file;
the identification value generating unit generates an identification value associated with the at least one file; and
the cache unit performs caching of the identification value associated with the at least one file and the information associated with the compressed file.

5. The terminal as claimed in claim 1,
wherein the detecting unit determines information associated with a process when the at least one file is generated from the process in the case where the at least one file is generated through the predetermined process;
the identification value generating unit generates an identification value associated with the at least one file; and
the cache unit performs caching of the identification value associated with the at least one file and the information associated with the process.

6. The terminal as claimed in claim 1, wherein the extracting unit comprises:
a determining unit to determine, based on the extracted distributor information, whether the new file is distributed from another file; and
a distribution route tracing unit to extract, based on an identification value of the other file, distributor information of the other file from the cache unit and to trace a distribution route of the new file when the new file is distributed from the other file.

7. A method for a terminal to determine a file distributor, the method comprising:
managing a database (DB) storing an identification value associated with at least one file pre-executed in the terminal and distributor information associated with the at least one file;
detecting whether a new file is generated in the terminal;
generating an identification value of the new file when the generation of the new file is detected; and
extracting, from the DB, distributor information associated with a file having an identification value identical to the identification value of the new file.

8. The method as claimed in claim 7, further comprising:
determining, based on the extracted distributor information, whether the new file is distributed from another file; and
extracting distributor information associated with the other file from the data base (DB) based on an identification value of the other file, and tracing a distribution route of the new file when the new file is distributed from the other file.

9. A computer-readable recording medium in which a program for executing a method as claimed in claim 7 is recorded.

10. A computer-readable recording medium in which a program for executing a method as claimed in claim 8 is recorded.
